(19) United States
(12) Patent Application Publication
(10) Pub. No.: US 2023/0151685 A1
(43) Pub. Date: May 18, 2023

(54) ROMAN SHADE CURTAIN HAVING VIEWING PART

(71) Applicant: HEE JIN PARK, Gyeonggi-do (KR)

(72) Inventor: HEE JIN PARK, Gyeonggi-do (KR)

(21) Appl. No.: 18/097,284

(22) Filed: Jan. 16, 2023

Related U.S. Application Data
(63) Continuation of application No. PCT/KR2021/008571, filed on Jul. 6, 2021.

(30) Foreign Application Priority Data
Jul. 24, 2020 (KR) 10-2020-0092003

(51) Int. Cl. E06B 9/38; E06B 9/262

(52) U.S. Cl. CPC E06B 9/38; E06B 9/262; E06B 2009/2622

(57) ABSTRACT

The present invention relates to a roman shade curtain which can improve the atmosphere of a curtain and the interior design of a home as the curtain is unfolded or folded up in a stepwise manner like lace and, particularly, to a roman shade curtain having viewing parts which enable outdoor viewing and light transmission. The present invention implements a new type roman shade curtain comprising viewing parts formed at intervals and formed of materials such as mesh, and a sub-curtain for opening and closing of the viewing parts, the sub-curtain being able to selectively open and close the viewing parts, such that a user can view the outside or enable outside light to enter through the viewing parts, as necessary.

### CROSS-REFERENCE TO RELATED APPLICATION

This application is a US Bypass Continuation Application of International Application No. PCT/KR2021/008571, filed on Jul. 6, 2021, and designating the United States, the International Application claiming a priority date of Jul. 24, 2020, based on prior Korean Application No. 10-2020-0092003, filed on Jul. 24, 2020, the disclosure of which is incorporated herein by reference in its entirety.

### BACKGROUND

### Technical Field

The present disclosure relates to a roman shade curtain which is capable of improving a curtain atmosphere and the interior of a house by folding or unfolding the curtain in a stepwise manner like a lace, and more particularly, to a roman shade curtain having a viewing part for viewing outdoor and light-transmitting.

### Background Art

In general, curtains are used to cover light or objects in everyday life, such as covering the sunlight or covering the stage.

Such curtains may be classified into various types according to their shapes, for example, a normal curtain that is unfolded and folded to the left and right sides, a vertical blind that is composed of a plurality of pieces for adjusting a tilt angle, a roll screen curtain which is wound and unwound on a roll which is rotated, and a roman shade curtain which is folded or unfolded in a stepwise manner by winding a length adjusting wire.

Recently, as not only the function of the curtain but also the aesthetic elements are considered important, the roman shade curtain, which has a beautiful folding shape, is gaining popularity.

The roman shade curtain has a beautiful appearance when the roman shade is unfolded and/or completely lifted because a plurality of wrinkles is fundamentally formed as the curtain unit is folded and lifted of unfolded and lowered.

Various forms of roman shade curtains are disclosed in Korean Patent Application Publication No. 10-2012-0004893, Korean Patent Application Publication No. 10-2013-0134723, Korean Patent Application Publication No. 10-2014-0015172, Korean Patent Application Publication No. 10-2014-0015178, and Korean Patent Application Publication No. 10-2014-0015179.

On the other hand, most of the existing roman shade curtains are very effective in protecting privacy and blocking the outside like general curtains when the windows or living room windows are covered by being completely unfolded, but they are not only difficult to view the outside from the inside, but also insufficient to create various indoor atmospheres by completely blocking the external light.

### SUMMARY

### Technical Problem

Therefore, the present disclosure was devised considering these issues. An object of the present disclosure is to provide a roman shade curtain having a viewing part made of a material such as a mesh in the middles of the curtain, and a sub-curtain for opening and closing the viewing part to selectively open or close. Accordingly, a new type of roman shade curtain is implemented with the viewing part through which a user may view outdoor as needed or external light is allowed to enter. Thus, the roman shade curtain may maintain the characteristics thereof, and be possible to view outside and transmit light, thereby to improve the functionality and practicality of the curtain, enhance ease of use, and create various indoor atmosphere.

### Technical Solution

In order to achieve the above object, the roman shade curtain having the viewing part provided in the present disclosure has the following characteristics.

As an exemplary embodiment of the present disclosure, the roman shade curtain having a viewing part includes a winding roll device which unwinds or winds a main driving wire and a sub-driving wire while having a main operation wire and a sub-operation wire for unfolding and folding a curtain; a main curtain which is supported on the winding roll device, has a plurality of viewing parts arranged in a horizontal direction while having a constant width in the middles of a vertical length, has a plurality of tubular-shaped main rod insertion units having at least one main cut-out unit on the rear side, and is connected to the main driving wire; a main rod inserted in parallel to the main rod insertion unit of the main curtain; a plurality of main rings inserted into the main driving wire through the main wire hanging unit on the upper end and inserted into the main rod through the main rod hanging unit on the lower end, and located in the main cut-out unit; a plurality of sub-curtains connected to the sub-driving wire, in which the sub-curtains are disposed at positions corresponding to those of the viewing part on the rear surface of the main curtain, are attached to the rear surface of the main curtain through the upper end so as to be folded or unfolded to open or close the viewing part, and have, on the lower end thereof, a plurality of tubular sub-rod-insertion units having at least one sub-cut-out unit; a sub-rod inserted in parallel with the sub-rod insertion unit of the sub-curtain; and a plurality of sub-rings coupled to the sub-driving wire through the sub-wire hanging unit on the upper end, inserted into the sub-rod through the sub-rod hanging unit on the lower end, and positioned on the sub-cut-out unit.

Here, the viewing part of the main curtain may be made of a mesh material, a transparent vinyl material, or the like.

In addition, the main-rod insertion unit of the main curtain and the sub-rod insertion unit of the sub-curtain may be formed by bonding a two-layered folded band-shaped fabric with the rear surface portion of the curtain, or may be integrally formed with the curtain through double weaving when the curtain is woven.

The main rod-hanging unit of the main ring and the sub-rod-hanging unit of the sub-ring are formed into a ring shape, and may be connected to the main rod and the sub-rod by respective insertion structures.

In a preferred exemplary embodiment, the main rod-hanging unit of the main ring and the sub-rod-hanging unit of the sub-ring are formed in a spherical shape, and the main rod and the sub-rod are formed in a tubular shape having slots parallel along the longitudinal direction of the rod, such that the main rod-hanging unit and the sub-rod-hanging unit may be connected to each other in a slide fitting structure inside of the main rod and sub-rod.

Meanwhile, according to an exemplary embodiment of the present disclosure, the roman shade curtain may include a rod and a ring used for lifting or lowering a curtain in the roman shade curtain, in which a main rod-hanging unit of a main ring and/or a sub-rod-hanging unit of a sub-ring are formed in a spherical shape, and the main rod and/or the sub-rod are formed into a tubular shape having slots parallel along the longitudinal direction of the rod, such that the main rod-hanging unit and/or the sub-rod-hanging unit may be connected in a slide fitting structure inside of the main rod and/or sub-rod.

### BRIEF DESCRIPTION OF THE DRAWINGS

FIGS. 1 and 2 are perspective views illustrating a roman shade curtain having a viewing part according to an exemplary embodiment of the present disclosure.

FIG. 3 is a cross-sectional view illustrating a roman shade curtain having a viewing part according to an exemplary embodiment of the present disclosure.

FIG. 4 is a perspective view illustrating a winding roll device in a roman shade curtain having a viewing part according to an exemplary embodiment of the present disclosure.

FIG. 5 is a perspective view illustrating various coupling forms of a rod and a ring in a roman shade curtain having a viewing part according to an exemplary embodiment of the present disclosure.

FIG. 6 is a perspective view illustrating an open state of a viewing part in the roman shade curtain having a viewing part according to the exemplary embodiment of the present disclosure.

### DETAILED DESCRIPTION

Hereinafter, the present disclosure will be described in detail with reference to the accompanying drawings.

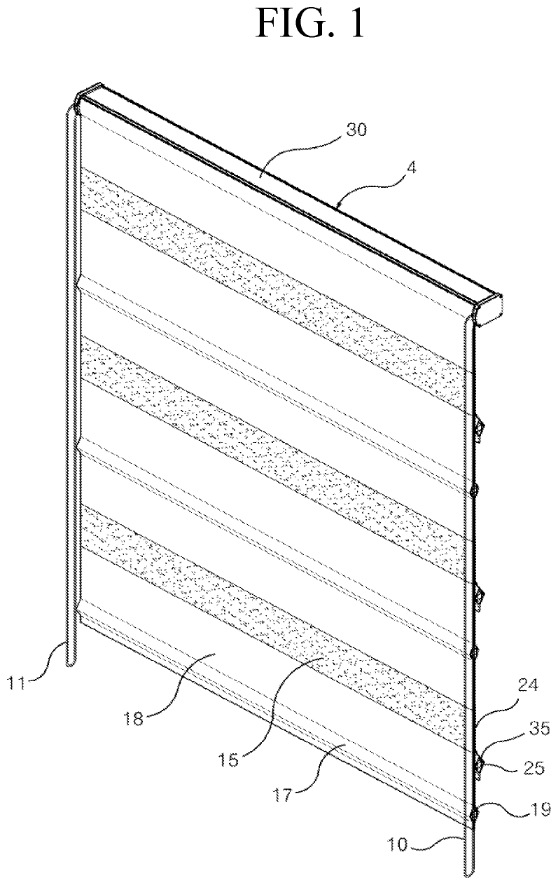

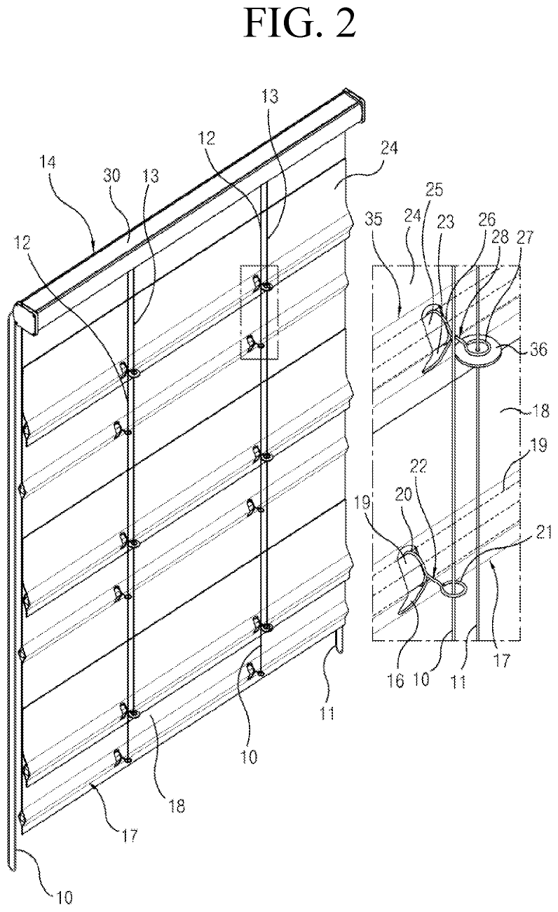

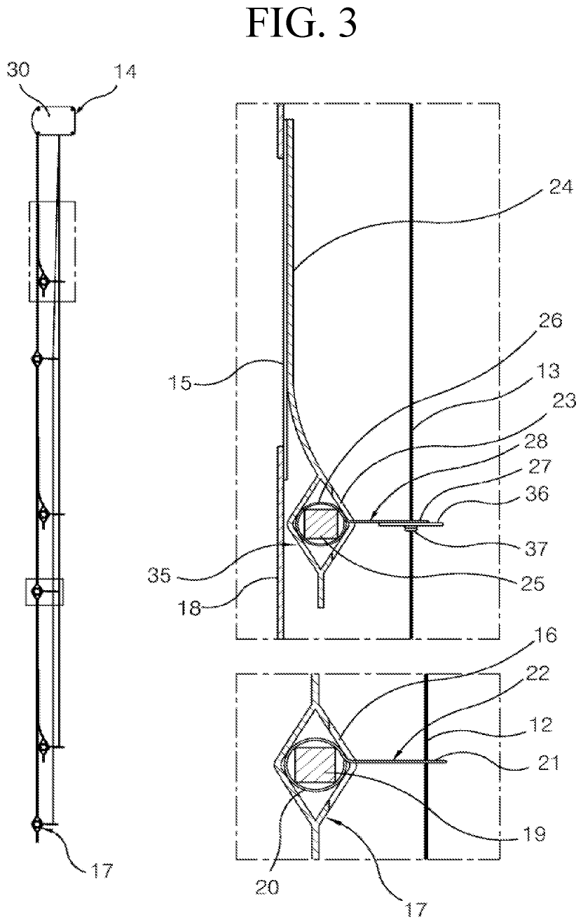

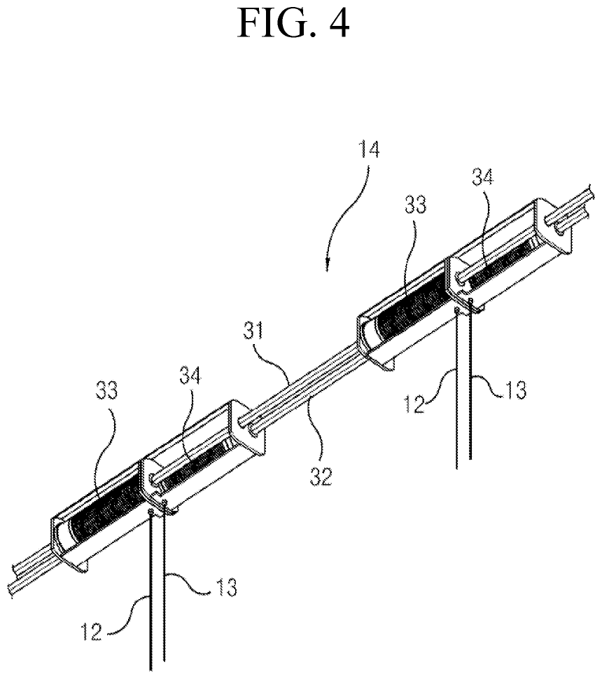

FIGS. 1 and 2 are perspective views illustrating a roman shade curtain having a viewing part according to an exemplary embodiment of the present disclosure, FIG. 3 is a cross-sectional view illustrating a roman shade curtain having a viewing part according to an exemplary embodiment of the present disclosure, and FIG. 4 is a perspective view illustrating a winding roll device in the roman shade curtain having a viewing part according to an exemplary embodiment of the present disclosure.

As shown in FIGS. 1 to 4, the roman shade curtain having a viewing part includes a winding roll device 14 as a means for providing power for folding and unfolding operation of a curtain.

The winding roll device 14 is a device which winds or unwinds a main driving wire 12 and a sub-driving wire 13 when a main curtain 18 and a sub-curtain 24 are folded or unfolded, and may be installed in a transverse direction at an upper end portion of a window, a living room window, or the like, for use.

To this end, the winding roll device 14 includes a case 30 in the form of a square bar, and a main winding shaft 31 and a sub-winding shaft 32 having a square cross section are installed in parallel in the case 30, and a main winding roll 33 and a sub-winding roll 34 for winding or unwinding the main driving wire 12 and the sub-driving wire 13 are installed in the main winding shaft 31 and the sub-winding shaft 32, respectively.

The main driving wire 12 and the sub-driving wire 13 are wound around the main winding roll 33 and the sub-winding roll 34, respectively.

Here, a known gear device (not shown) is installed at each end of the main winding shaft 31 and the sub-winding shaft 32, and in this case, the respective gear devices are disposed at each of both sides of the case 30 to connect to the main operation wire 10 and the sub-operation wire 11, respectively, which are elongated downward.

Therefore, when the main operation wire 10 is operated, the main winding shaft 31 and the main winding roll 33 rotate to unwind or wind the main driving wire 12, and as a result, the main curtain 18 is unfolded or folded according to the unwinding or winding of the main driving wire 12, and when the sub-operation wire 11 is operated, the sub-winding shaft 32 and the sub-winding roll 34 rotate to unwind or wind the sub-driving wire 13, and as a result, the sub-curtain 24 is unfolded or folded according to the unwinding or winding of the sub-driving wire 13.

For example, in the case of the main curtain 18, since the main driving wire 12 is coupled to the lowermost portion of the main curtain 18, when the main driving wire 12 is wound on the main winding roll 33, the main curtain 18 is lifted from the lower portion thereof to be folded one by one, or when the main driving wire 12 is unwound from the main winding roll 33, the main curtain 18 is lowered from the lower portion thereof to be sequentially unfolded.

Further, in the case of the sub-curtain 24, the sub-driving wires 13 are coupled to the respective sub-curtain 24 sides in the middles of the length of the main curtain 18, so that when the sub-driving wires 13 are wound on the sub-winding rolls 34, the lower end portions of the respective sub-curtain 24 are lifted to be folded, or when the sub-driving wires 13 are unwound from the sub-winding rolls 34, the lower end portions of the respective sub-curtain 24 are lowered to be simultaneously unfolded.

The present disclosure shows a form in which a pair of main winding rolls 33 and sub-winding rolls 34 are applied, and accordingly, each of two wires of main driving wires 12 and sub-driving wires 13 extending from the respective winding rolls can stably pull or release each of both sides of the main curtain 18 and the sub-curtain 24, and as a result, the main curtain 18 and the sub-curtain 24 can be folded or unfolded in a balanced manner.

In addition, the roman shade curtain having the viewing part includes a main curtain 18 made of fabric material, a synthetic resin material, or the like.

The upper end portion of the main curtain 18 may be supported in a structure of being attached to the case 30 of the winding roll device 14, and in this case, the main curtain 18 may be maintained in a flat state without being fluttered by the weight of the main rod 19.

On the rear surface of the main curtain 18, a plurality of tubular main rod insertion units 17 having at least one main cut-out unit 16, for example, two cut-out units 16 disposed in the horizontal width direction of the curtain, is formed, and each of the main rod insertion units 17 formed as described above may be disposed in parallel along the horizontal width direction of the curtain and disposed at constant intervals in the longitudinal direction of the curtain.

In this case, the main rod insertion unit 17 may be formed by bonding the two-layered folded band-shaped fabric with the rear surface portion of the main curtain 18.

For example, a long band-shaped fabric made of the same material as the material of the main curtain 18 is prepared, both ends of the fabric in the width direction are folded inwardly in parallel to face each other in the middles of the width so as to be entirely double-layered, and then an adhesive such as hot melt is applied to the ends of the inwardly folded portions, that is, the ends that are in contact with each other.

Subsequently, when the inside of the fabric coated with hot melt or the like closely adheres to the rear surface of the main curtain 18 and is bonded by applying heat, one layer of the inside of the main rod insertion unit 17, that is, one layer made of the inwardly folded portion, is attached to the rear surface of the main curtain 18, the one layer of the outside may form a space between the one layer of the inside, and the main rod 19 may be fitted into the space formed in this way.

Here, the cut-out unit of the rod insertion unit 17 may be formed on one outer layer that is not attached to the rear surface of the curtain 18.

Further, in order to prevent the one outer layer from being attached to the one inner layer at the time of the thermal bonding of the circular plate, a release paper (not shown) such as a thin vinyl or film is attached to the inner side of the two-layered main rod insertion unit 17, that is, the inner side of the one outer layer, such that the adhesive such as hot melt applied to the one inner layer and the one outer layer may be blocked by the release paper, and as a result, the two-layered fabric is not attached to each other due to the release paper at the time of the thermal bonding.

In addition, the main rod insertion units 17 may be formed at intervals that are relatively widened from the upper end portion of the curtain toward the lower end portion of the curtain.

As described above, by adopting the method of attaching and fixing the main rod insertion unit 17 in the heat bonding method, the manufacturing may be easily performed as compared with the method of backstitching one by one using the sewing method, and as a result, mass production is possible, thereby improving productivity.

As another example, in the case of the main rod insertion unit 17, in addition to a method of attaching and forming the separate fabric in a heat bonding manner, the middles portion of the main curtain 18 in the up-and-down longitudinal direction may be folded in a round manner so as to form a space sufficient for the main rod 19 to be inserted, and then the overlapped portion may be stitched to form a space.

As another example, as a method of forming the main rod insertion unit 17, the main rod insertion unit 17 may be integrally formed through a double weaving method during the main curtain 18 weaving.

For example, when the main curtain 18 is woven, the following process is repeated: while the curtain body is woven in a single layer, the curtain body is woven in a double layer at a position where the main rod insertion unit is formed to form a space (main rod insertion unit) into which the rod is fitted, and while the curtain body is woven in a single layer again, the curtain body is woven in a double layer at a position where the main rod insertion unit 17 is formed thereunder to form a space (main rod insertion unit) into which the rod is fitted, and the like, thereby integrally forming the plurality of main rod insertion units 17 through weaving on the main curtain 18.

As described above, since the main rod insertion unit 17 is integrally formed with the curtain through weaving, productivity related to the curtain manufacturing may be improved, and as a result, the curtain may be mass-produced.

Each main rod 19 may be fitted into each main rod insertion unit 17 on the rear surface of the main curtain 18, and the main rod 19 may be formed of a rectangular rod or a circular rod, such as a metal material or a plastic material, having a predetermined weight.

Meanwhile, the plurality of main rod insertion units 17 woven on the main curtain 18 may be disposed at intervals in which intervals which are relatively increased from the upper end portion of the curtain to the lower end portion of the curtain.

For example, the interval between the main rod insertion unit 17 disposed at the uppermost end of the main curtain 18 and the main rod insertion unit 17 disposed immediately below the main rod insertion unit 17 is relatively smallest, and the interval between the main rod insertion units 17 is gradually increased as it goes downward, and the interval between the main rod insertion unit 17 disposed at the lowermost end of the main curtain 18 and the main rod insertion unit 17 disposed immediately above thereof is relatively largest.

As a result, the interval between the main rod insertion units 17 is increased as it goes down the main curtain 18.

Further, the main rod insertion unit 17 formed on the main curtain 18, that is, the main rod insertion unit 17 woven together when the main curtain 18 is woven, may be woven in parallel in the width direction of the fabric or in parallel in the length direction of the circular plate.

As an example, when the main curtain 18 is woven, the main curtain 18 is formed by weaving the curtain fabric in the direction of the fabric width W (horizontal direction), the main rod insertion unit 17 may be woven in parallel in the direction of the fabric width W.

As another example, when the main curtain 18 is woven in the direction of the fabric length L (vertical direction) to manufacture the main curtain 18, the main rod insertion unit 17 may be woven in parallel in the direction of the fabric length L, and in this case, the main curtain 18 may be laid one its side so that the main rod insertion unit 17 may take a horizontal posture (the fabric length is laid left-and-right, and the fabric width is laid up-and-down).

When the curtain is woven in this manner, the main rod insertion units (similarly, the main rod insertion units attached to the curtain) integrally formed by being woven together are arranged at intervals that are relatively widened from the upper end portion of the curtain toward the lower end portion of the curtain so as to vary the intervals between the main rod insertion units, thereby uniformly maintaining a folded shape as a whole when the curtain is folded and raised (when the roman shade is folded and raised) and thus further improving the aesthetic characteristics of the roman shade.

In particular, the main curtain 18 includes a viewing part 15 as a means for allowing external light to enter the room as well as external view.

The viewing part 15 may be made of a mesh material, a transparent vinyl material, or the like, and the viewing part 15 may be formed of a plurality of viewing parts having a predetermined width in the middles of the up-and-down length of the main curtain 18 and disposed in the horizontal direction.

For example, the plurality of viewing parts 15 is formed in a band shape having a predetermined width and a length corresponding to a left-and-right width of the main curtain 18, and the viewing parts 15 are horizontally disposed in parallel at a predetermined interval in up-and-down longitudinal direction of the main curtain 18 and are attached or bonded to the main curtain 18 through upper and lower end portions thereof.

Accordingly, when the main curtain 18 is unfolded, the outside may be viewed through the portion where the viewing part 15 is installed at places, and the external light can be introduced into the room through the viewing part 15.

Further, the roman shade curtain having the viewing part includes a plurality of main rings 22 installed on the rear surface of the main curtain 18.

The main ring 22 may be formed in various shapes, and as an example, the main ring 22 may be formed in the shape of a ring by bending a wire or the like, and in this case, have a main wire hanging unit 20 is formed at an upper end portion thereof and a main rod hanging unit 21 is formed at a lower end portion thereof, in which the main driving wire 12 passes through the main wire hanging unit 20 formed as described above, and in which the main rod 19 may be fitted into the main rod hanging unit 21.

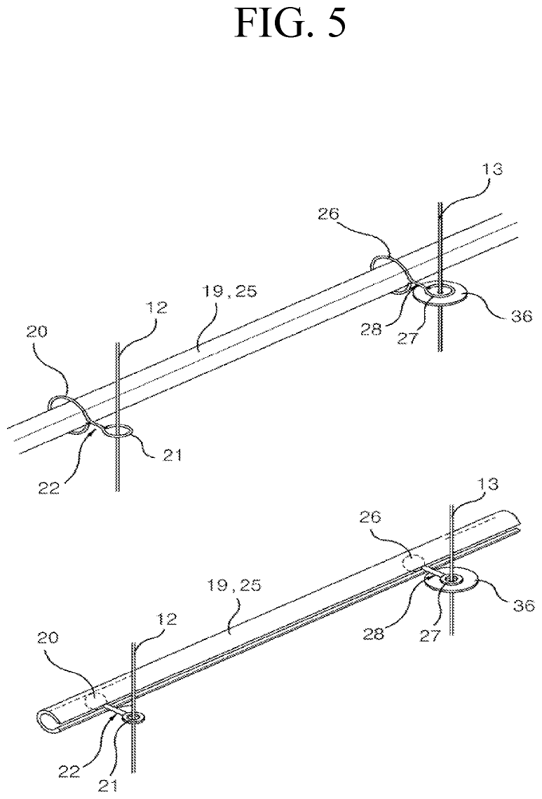

For example, as shown in FIG. 5, the main ring 22 is positioned at the main cut-out unit 16 formed in the main rod insertion unit 17 on the rear surface of the main curtain 18, and the main rod hanging unit 21 of the main ring 22 positioned in this way hangs the main rod 19 fitted in the main rod insertion unit 17 while the main driving wire 12 passes through the upper main wire hanging unit 20.

Here, the end portion of the main driving wire 12 extending downward through the main wire hanging unit 20 of each main ring 22 is coupled to the main wire hanging unit 20 of the main ring 22 on the main rod 19 at the lowermost portion of the main curtain 18 by a knot shape or by a washer-shaped hanging piece put on the knot, and accordingly, when the main driving wire 12 is pulled and wound upward, the main curtain 18 can be folded sequentially while being lifted from the lower end portion.

As another example, as shown in FIG. 5, the main ring 22 may be formed in the form of an integrated injection-molded product of an upper end ring and a lower end sphere, and in this regard, the main rod 19 may be formed in a tubular shape having slots 29 parallel to each other in the longitudinal direction of the rod.

Accordingly, the main ring 22 may be connected to the main rod 19 in a slide fitting structure into the main rod 19 formed in a hollow tubular shape, using the main rod hanging unit 21 formed in the lower end sphere, and the main driving wire 12 may pass through the main wire hanging unit 20 formed in the upper end ring.

Further, the roman shade curtain having the viewing part includes a plurality of sub-curtains 24 as a means for opening and closing the viewing part 15 disposed on the main curtain 18.

Like the main curtain 18, the sub-curtain 24 may be made of fabric material, a synthetic resin material, or the like, and in this case, the sub-curtain 24 is formed in a band shape having a width slightly larger than the up-and-down width of the viewing part 15 and having the same length as the left-and-right length of the viewing part 15 (the same size as the horizontal width of the main curtain).

The sub-curtain 24 may be disposed in parallel at a position corresponding to the position of the viewing part 15 on the rear surface part of the main curtain 18, and may be attached to the rear surface of the main curtain 18 by adhesion, bonding, or backstitching through an upper end thereof, and may be folded or unfolded in the above-described state to open or close the viewing part 15.

That is, in the state in which the sub-curtain 24 is completely unfolded downward, the viewing part 15 is completely blocked, and in the state in which the sub-curtain 24 is folded upward, the viewing part 15 is opened to secure a view through the viewing part 15.

At a lower end portion of the sub-curtain 24 as described above, a plurality of tubular sub-rod insertion units 35 having at least one sub-cut-out unit 23, for example, two sub-cut-out units 23 disposed in a left-and-right width direction of the curtain is formed, and each of the sub-rod insertion units 35 formed this way may be disposed in parallel in the left-and-right width direction of the curtain and, at the same time, disposed at a lower end portion of each sub-curtain 24 disposed in a up-and-down longitudinal direction of the main curtain 18.

In this case, the sub-rod insertion unit 35 may be formed by bonding a two-layered folded band-shaped fabric with the rear surface portion of the main curtain 18, but, preferably, may be integrally formed with the sub-curtain 24 through double weaving when the sub-curtain 24 is woven.

As described above, since the sub-rod insertion unit 35 is integrally formed with the curtain through weaving, productivity related to the curtain manufacturing may be improved, and as a result, the curtain may be mass-produced.

Each sub-rod 25 may be fitted into each sub-rod insertion unit 35 formed on the rear surface of the sub-curtain 24, and the sub-rod 25 may be formed of a rectangular rod or a circular rod, such as a metal material or a plastic material having a predetermined weight.

Further, the roman shade curtain having the viewing part includes a plurality of sub-rings 28 installed on the rear surface part of the sub-curtain 24.

The sub-ring 28 may be formed in various shapes, for example, the sub-ring 28 may be formed in the shape of a ring made by bending a wire or the like, and has a sub-wire hanging unit 26 formed at an upper end portion thereof, and a sub-rod hanging unit 27 formed at a lower end portion thereof, in which the sub-driving wire 13 is tied by a knot or the like after passing, and in which the sub-wire is fitted into the sub-rod hanging unit 27.

For example, as shown in FIG. 5, the sub-ring 28 is positioned at the sub-cut-out unit 23 formed in the sub-rod insertion unit 35 on the lower end portion of the sub-curtain 24, and the lower sub-rod hanging unit 27 of the sub-ring 28 positioned in this way hangs the sub-rod 25 fitted in the sub-rod insertion unit 35, while the sub-driving wire 13 is tied to the upper sub-wire hanging unit 26.

Here, the sub-driving wire 13 extending downward through the sub-wire hanging unit 26 of each sub-ring 28 may be tied to the sub-ring 28 by a washer-shaped hanging piece 36 placed on the knot 37 at the position of the sub-wire hanging unit 26 of each sub-ring 28, which is tied to each sub-rod 25 fitted into the sub-rod insertion unit 35 of each sub-curtain 24.

That is, the sub-driving wire 13 is knotted at intervals corresponding to the pitches between the sub-wire-hanging units 26 of each sub-ring 28, and at this time, washer-shaped hanging pieces 36 are respectively fitted on the knots, and the hanging piece 36 fitted in this way is hung in the upward direction with the sub-wire-hanging unit 26 of the sub-ring 28 so that when the sub-driving wire 13 is pulled and wound in the upward direction, each sub-curtain 24 is simultaneously pulled and folded in the upward direction, and when the sub-driving wire 13 is lowered and unwound in the downward direction, each sub-curtain 24 is simultaneously unfolded.

As another example, as shown in FIG. 5, the sub-ring 28 may be formed in the form of an integrated injection-molded product of an upper end ring and a lower end sphere, and in this regard, the sub-rod 25 may be formed in a tubular shape having slots 29 parallel to each other in the longitudinal direction of the rod.

Accordingly, the sub-ring 28 may be connected to the sub-rod 25 in a slide fitting structure inside of the sub-rod 25 formed in the hollow tubular shape using the sub-rod hanging unit 27 formed in the lower end sphere, and the sub-driving wire 13 may be tied to the hanging piece 36 in the sub-wire hanging unit 26 formed in the upper end ring.

Therefore, the use state of the roman shade curtain having the viewing part configured as described above will be described as follows.

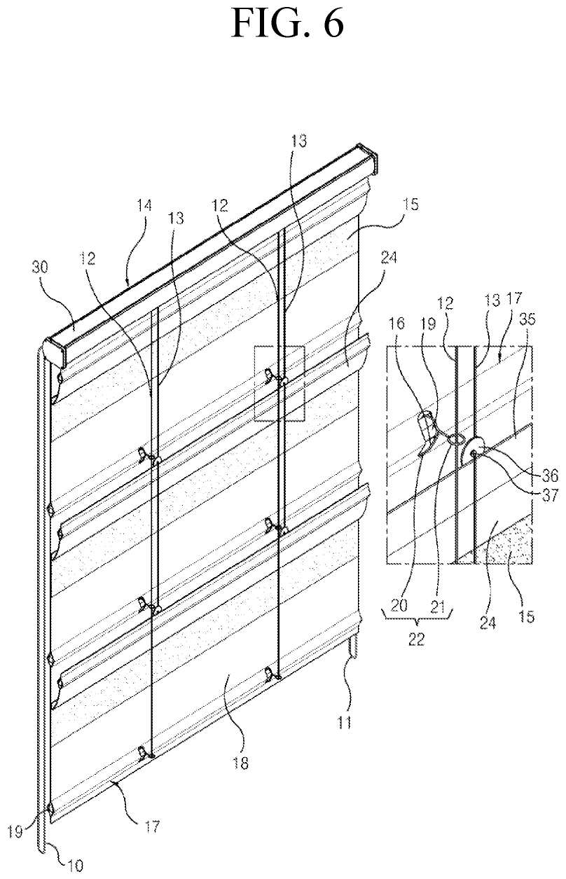

FIG. 6 is a perspective view showing a viewing part open state in a roman shade curtain having a viewing part according to an exemplary embodiment of the present disclosure.

As shown in FIG. 6, when the main curtain 18 is unfolded, if the user pulls one side of any of the main operation wire 10 downward, the main driving wire 12 wound around the winding roll device 14 is unwound, that is, the main curtain 18 is unfolded downward by its own weight, thereby making it possible to boost the unique atmosphere of the roman shade curtain and the interior of the house.

When the main curtain 18 is folded, if the user pulls the other side of the main operation wire 10 downward, the main driving wire 12 is wound around the winding roll device 14, and at the same time, the main curtain 18 is pulled upward from the lower end portion in a state of being folded one by one, and as a result, the main curtain 18 may be folded.

Even at this time, the main curtain 18 is not completely unfolded, but is in a state folded in a stepwise manner like a lace.

Meanwhile, when the sub-curtain 24 is unfolded, if the user pulls down any one side of the sub-operation wire 11, the sub-driving wire 13 wound around the winding roll device 14 is unwound, and at the same time, the sub-curtain 24 is unfolded down by its own weight.

In this state, the sub-curtain 24 completely blocks the rear side of the viewing part 15 in the main curtain 18, and thus, the external view as well as the light from the outside may be blocked.

When the sub-curtain 24 is folded, if the user pulls the other side of the sub-operation wire 11 downward, the sub-driving wire 13 is wound around the winding roll device 14, and at the same time, the sub-curtain 24 is pulled upward and folded.

In this state, since the rear side of the viewing part 15 in the main curtain 18 is opened, the outside can be viewed through the viewing part 15, thereby making it possible to secure a cool indoor atmosphere that is stuffy, and also, as external light or the like enters the room through the viewing part 15, it is possible to further enhance the indoor view.

The roman shade curtain having the viewing part, according to an exemplary embodiment of the present disclosure, has the following effects.

First, the present disclosure adopts a combination of a viewing part made of a material such as a mesh formed in the middles of a curtain, and a sub-curtain for opening and closing the viewing part capable of selectively opening and closing the viewing part, thereby enabling a user to open the viewing part as needed to view outside or allow external light. Therefore, according to an exemplary embodiment of the present disclosure, the roman shade curtain has effects of improving the functionality and practicality of the curtain, enhancing ease of use, and creating various indoor atmosphere by enabling an external view and light transmission while maintaining the unique characteristics of the roman shade curtain.

Second, the entire structure of the curtain may be simply and easily manufactured, and manufacturing cost may be reduced.

Thirdly, the curtain of the present disclosure has a structure which supports the unfolding and the folding operations of the curtain fabric by using a driving wire, a ring, and a rod, thereby obtaining excellent durability even when repeatedly unfolded and folded. Fourth, rods and rings, as well as the driving wire for the operation of the curtain, are disposed behind the curtain so as not to be exposed to the front surface of the curtain at all, thereby improving the appearance of the curtain.

Fifth, when a rod insertion unit or inserting a rod into the curtain fabric is formed, the rod insertion unit may be formed with the curtain by weaving together with the rod insertion unit during the weaving of the curtain fabric, or by forming the rod insertion unit by thermal bonding and adhering a sheet fabric having a two-layered band-shape to the rear surface of the curtain fabric, thereby improving the productivity of a curtain including the rod insertion unit and also securing the quality of a product so as not to show a sense of difference such as backstitching, on the front surface of the curtain.

As described above, the present disclosure provides a novel type of roman shade curtain in which a viewing part made of a material such as mesh or the like is formed on a portion of the curtain, and the viewing part formed as described above can be selectively opened/closed, and thus the present disclosure can improve functionality and practicality of the curtain, increasing the convenience of use, while maintaining the unique features of the roman shade curtain, and can improve the indoor view while creating various indoor moods by enabling an external view and light transmission.

What is claimed is:

1. A roman shade curtain having the viewing part, comprising:
a winding roll device (14) which unwinds or winds a main driving wire (10) and a sub-driving wire (11) while having a main operation wire (10) and a sub-operation wire (11) for unfolding and folding a curtain,
a main curtain (10) which is supported on the winding roll device (14), has a plurality of viewing parts (15) arranged in a horizontal direction while having a constant width in the middles of a vertical length, has a plurality of tubular-shaped main rod insertion units (17) having at least one main cut-out unit (16) on the rear side, and is connected to the main driving wire (12),
a main rod (19) inserted in parallel to the main rod insertion unit (17) of the main curtain (18),
a plurality of main rings (22) inserted into the main driving wire (12) through the main wire hanging unit (20) on the upper end and inserted into the main rod (19) through the main rod hanging unit (12) on the lower end, and located in the main cut-out unit (16),
a plurality of sub-curtains (24) connected to the sub-driving wire (13), in which the sub-curtains (24) are disposed at positions corresponding to those of the viewing part (15) on the rear surface of the main curtain (18), are attached to the rear surface of the main curtain (18) through the upper end so as to be folded or unfolded to open or close the viewing part (15), and have, on the lower end thereof, a plurality of tubular sub-rod-insertion units (15) having at least one sub-cut-out unit (23),
a sub-rod (25) inserted in parallel with the sub-rod insertion unit (35) of the sub-curtain (24), and
a plurality of sub-rings (28) coupled to the sub-driving wire (13) through the sub-wire hanging unit (26) on the upper end, inserted into the sub-rod (25) through the sub-rod hanging unit (27) on the lower end, and positioned on the sub-cut-out unit (23).

2. The roman shade curtain having the viewing part of claim 1, wherein
the viewing part (15) of the main curtain (18) is made of a mesh material or a transparent vinyl material.

3. The roman shade curtain having the viewing part of claim 1, wherein
the main-rod insertion unit (35) of the main curtain (18) and the sub-rod insertion unit (35) of the sub-curtain (24) are formed by bonding a two-layered folded band-shaped fabric with the rear surface portion of the curtain.

4. The roman shade curtain having the viewing part of claim 1, wherein
the main-rod insertion unit (35) of the main curtain (18) and the sub-rod insertion unit (35) of the sub-curtain (24) are integrally formed with the curtain through double weaving when the curtain is woven.

5. The roman shade curtain having the viewing part of claim 1, wherein
the main rod-hanging unit (21) of the main ring (22) and the sub-rod-hanging unit (27) of the sub-ring (28) are formed into a ring shape, and connected to the main rod (19) and the sub-rod (25) by respective insertion structures.

6. The roman shade curtain having the viewing part of claim 1, wherein
the main rod-hanging unit (21) of the main ring (22) and the sub-rod-hanging unit (27) of the sub-ring (28) are formed in a spherical shape, and the main rod (19) and the sub-rod (25) are formed in a tubular shape having slots (29) parallel along the longitudinal direction of the rod, such that the main rod-hanging unit (21) and the sub-rod-hanging unit (27) are connected to each other in a slide fitting structure inside of the main rod (19) and sub-rod (25).

7. A rod and a ring used for lifting or lowering a curtain in the roman shade curtain, comprising:
a main rod-hanging unit (21) of a main ring (22) and/or a sub-rod-hanging unit (27) of a sub-ring (28) formed in a spherical shape, and
a main rod (19) and/or a sub-rod (25) formed into a tubular shape having slots (29) parallel along the longitudinal direction of the rod, such that the main rod-hanging unit (21) and/or the sub-rod-hanging unit (27) are connected in a slide fitting structure inside of the main rod (10) and/or sub-rod (25).
